(19) United States
(12) Patent Application Publication
(10) Pub. No.: US 2019/0068913 A1
(43) Pub. Date: Feb. 28, 2019

(54) METHOD OF REPORTING TRAFFIC VIOLATION

(71) Applicant: Austin Kim, Fresh Meadows, NY (US)

(72) Inventor: Austin Kim, Fresh Meadows, NY (US)

(21) Appl. No.: 15/687,890

(22) Filed: Aug. 28, 2017

(51) Int. Cl. H04N 5/77; G08G 1/017; H04N 1/21; G06Q 50/26

(52) U.S. Cl. CPC H04N 5/77; G08G 1/0175; H04N 2201/0084; G06Q 50/26; H04N 1/2112

(57) ABSTRACT

Provided is a method of reporting traffic violations using a vehicle black box image. The method of reporting traffic violations using a vehicle black box image includes preparing an image of the traffic violation, connecting to a website where a user reports the traffic violation and inputting traffic violation information. The image may be prepared by capturing the image of the traffic violation by a vehicle black box and storing the image in a separate storage medium other than the vehicle black box.

### TECHNICAL FIELD

The present invention relates to a method of reporting a traffic violation, and more particularly, to a method of reporting a traffic violation in which an image captured by an electronic recording device, such as a vehicle black box, is used as an evidence.

### BACKGROUND OF THE DISCLOSURE

Traffic violations are becoming more serious social problems in recent years. As drivers, bicyclist, or pedestrians, we all deal with traffic violations or violent drivers, such as those who pushes their way into a traffic lane without even glancing, a teenager who walk through an intersection because he is texting, or those who drive a sports car like they are in a car-racing game.

Many cities have a special service for non-emergency traffic violations where you can make a report. Some cities allow you to report a non-emergency traffic violation through a city website. In some cities, you can call a non-emergency police number to report a traffic violation and have all the information that you need to report written down for quick reference. In 2009, there were approximately 80 cities and counties in the United States with a special number for reporting the traffic violations, such as 311. In those cities, you can call the number and give the information to the operator when you want to report a non-emergency traffic violation.

When you call to make a report of a non-emergency traffic violation, you should be ready to provide the date and time of the violation, the location of the violation, and the information you have about the vehicle and driver involved in the violation.

However, most of drivers abiding by a law on the road may not go to file an incident report. As such, there are tools that let you document and report dangerous drivers or traffic violations. However, they are still limited in terms of providing the information of the traffic violation conveniently.

### SUMMARY OF THE DISCLOSURE

Disclosed is a method of reporting traffic violations using a vehicle black box image. The method of reporting a traffic violation according to an embodiment of the present invention includes: preparing an image of the traffic violation, connecting to a website where a user reports the traffic violation, and inputting traffic violation information.

The preparation of the traffic violation image further includes capturing the image of the traffic violation by an electronic recording device, e.g., a vehicle black box, mounted in a vehicle and transferring the image into a separate storage medium from the electronic recording device to store it in the separate storage medium.

In addition, the input of the traffic violation information may further include selecting a type of a traffic violation and uploading the image of the traffic violation stored in the separate storage medium as an evidence of the traffic violation.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flow chart illustrating a method of reporting traffic violations using a vehicle black box image according to an embodiment of the present invention;

FIG. 2 is a schematic view illustrating a range of space which can be captured by the vehicle black box according to an embodiment of the present invention;

FIG. 3 is a flow chart illustrating a step of preparing an image of traffic violation according to an embodiment of the present invention;

FIG. 4 is a flow chart illustrating a step of preparing an image of traffic violation according to an embodiment of the present invention;

FIG. 5 is a flow chart illustrating a step of inputting traffic violation information according to an embodiment of the present invention; and

FIG. 6 is a flow chart illustrating a method of reporting traffic violations using a vehicle black box image according to another embodiment of the present invention.

### DETAILED DESCRIPTION OF THE DISCLOSURE

Preferred embodiments of the present invention will be described in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a method of reporting traffic violations using a vehicle black box image according to an embodiment of the present invention will be described in detail.

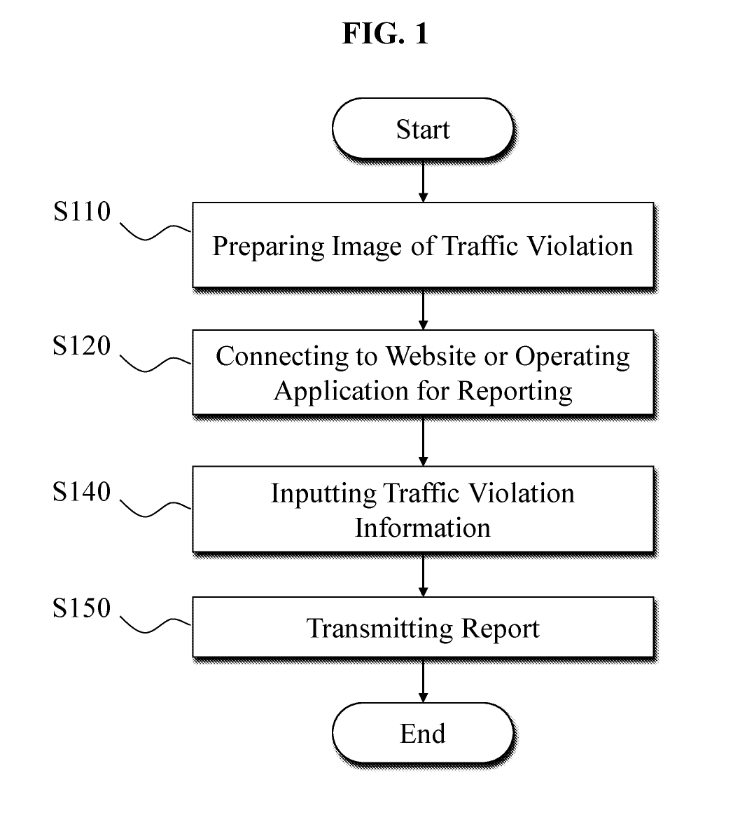

FIG. 1 is a flow chart illustrating the method of reporting traffic violations using a vehicle black box image according to an embodiment of the present invention. As shown in FIG. 1, an image of the traffic violation which occurs in violation to safe driving regulations is prepared at step S110. The image for the traffic violation can be obtained by an electric recording device. Example electric recording devices capable of capturing the image of the traffic violation include a vehicle black box mounted inside a vehicle, a cellular phone, a smart phone, a camera, or the like.

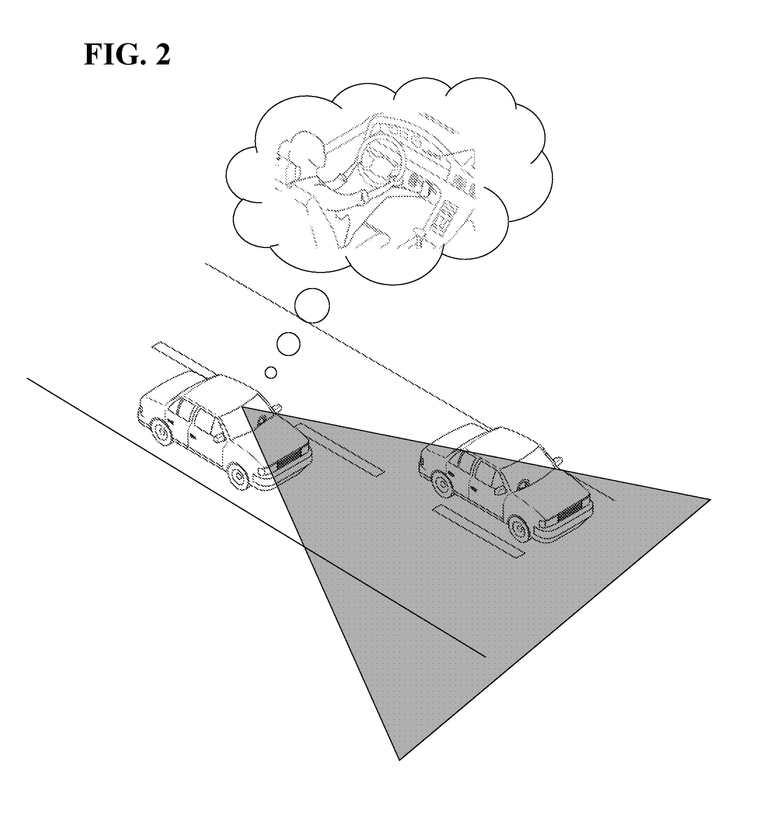

The vehicle black box is normally mounted inside a front windshield of the vehicle and captures images or videos of what happens in front of the vehicle. For example, the vehicle black box records videos in front of the vehicle for a predetermined time. FIG. 2 is a schematic view illustrating a range which can be captured by the vehicle black box according to an embodiment of the present invention. The vehicle black box can also record such information as a vehicle speed, a throttle position, airbag deployment times, whether or not the brakes were applied, whether or not seatbelts were worn, an engine speed, steering angles, and others.

The electric recording device is not limited to the vehicle black box, and can be modified into other recording devices, such as a camera or a smart phone, which is able to take a photo or video.

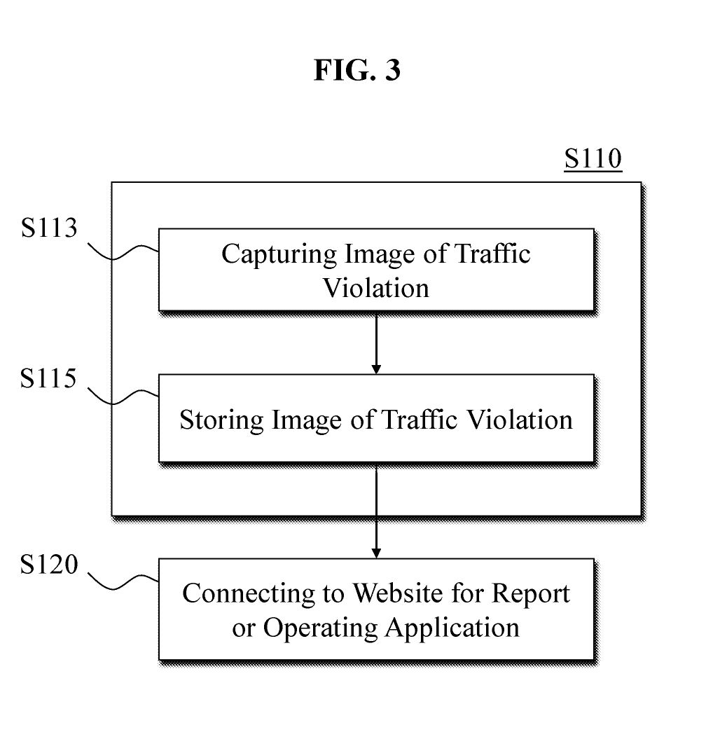

FIG. 3 is a flow chart illustrating the step of preparing an image of the traffic violation. The electric recording device, such as the vehicle black box or a camera, captures the image of traffic violations at step S113.

Here, the image captured by the vehicle black box is not limited to a static image, such as a picture or a photo. The image taken by the vehicle black box also includes moving pictures, e.g., a video or a movie. Thus, the image according to an embodiment of the present invention includes at least one of the picture image, photo image, video image, or movie.

In order to prepare the image of traffic violations, the image of the traffic violation captured by the electric recording device should be stored in the electric recording device or in a separate storage medium rather than the electric recording device at step S115.

In general, the image captured by the electric recording device can be stored in the device. For example, when a camera or a smart phone captures an image, the image is stored in the camera or in the smart phone, such as in a memory thereof. However, in the case of the vehicle black box, the images or videos recorded for a predetermined time may be overwritten when the driver continues to drive without storing the images or videos. For example, when the driver witnesses a traffic violation, if the driver continues to drive without storing the image into another storage medium, the images of the traffic violation may be lost due to being overwritten with other images. To prevent the image from being lost, when the driver witnesses a traffic violation, the driver may need to operate the electric recording device, e.g., the vehicle black box, to prevent the image from being overwritten. In an embodiment, the driver may push a button on the vehicle black box so as to store the image captured during a predetermined time period, such as five minutes, right before pushing the button.

Alternatively, the driver may store the image of the traffic violation in a separate storage medium rather than the electric recording device. The storage medium for storing the image may include a various electric storage medium, such as a smart phone storage, a cellular phone storage, a laptop storage, a personal computer (PC) storage, or a memory stick. Alternatively, the driver may upload the image of the traffic violation captured by the electric recording device in a network storage, such as a cloud storage or a cloud driver. Thus, the driver can use the image of the traffic violation when he or she reports the traffic violation at a later time.

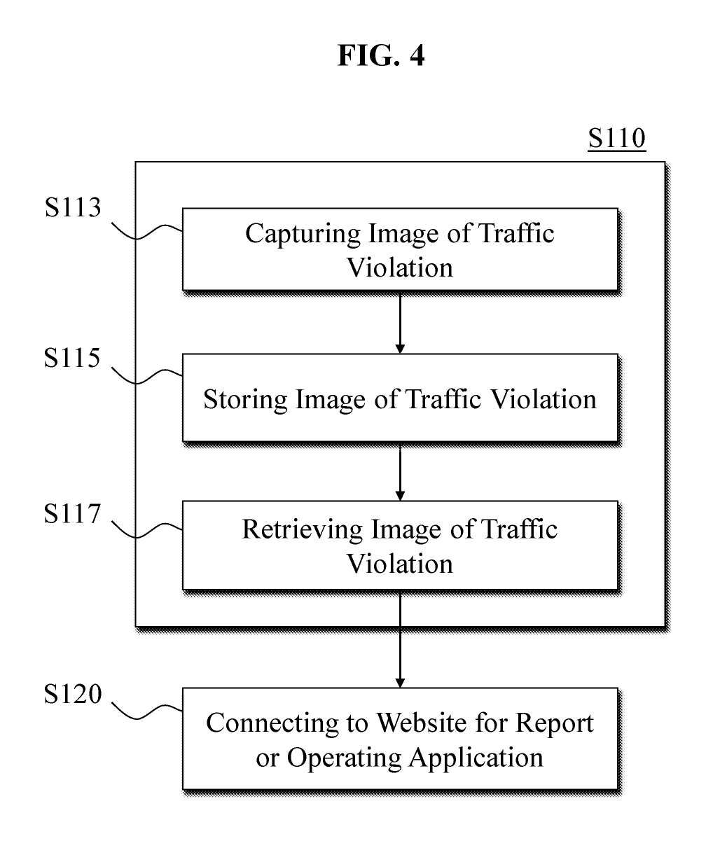

Here, as shown in FIG. 4, in case that the image of the vehicle black box is stored in a network storage or in case that the image is stored in a storage medium other than a device with which the driver reports the traffic violation, the driver may need to retrieve the image of the traffic violation (step S117). For example, the driver may download the image from a network storage or transferring the image from the medium where the image is stored to a device with which the user reports the traffic violation.

The traffic violation according to an embodiment of the present invention may include various illegal acts, including a speed violation, a signal violation, a lane violation, reckless driving, sudden stopping, driving in a “no-passing” zone, driving in a truck “no-passing” zone, a rotation violation, driving in a bus-only lane, intersection blocking, a parking violation, unlawful road occupation, the use of a cellular phone while driving, or illegal littering.

When the image of the traffic violation is captured and stored in a separate storage, the user may connect to a website through which the user can report the traffic violation at step 120 of FIG. 1. Otherwise, the user may run an application to begin the reporting of a traffic violation at this step.

The user may open a browser and input an address of a specific website to visit the website. The website according to an embodiment of the present invention may allow the user to report the traffic violation. The website may be provided by a city, a police department, or a third party which is related with reporting the traffic violation. For example, the web site may be managed by a third party, such as an application management center, which can forward the report including the image as an attachment to a police department or a city office.

Alternatively, the user may operate an application to report the traffic violation from a smart terminal, such as a smart phone. The application may be able to allow the user to be connected to the website through which the user can report the traffic violation. The application can be a form of being embedded in the smart terminal.

It is described using a smart phone as an example of the smart terminal. However, the smart terminal is not limited thereto. The smart terminal according to an embodiment of the present invention may include a smart phone, a cellular phone, a phablet, a tablet, a laptop, a personal computer (PC), or a personal digital assistant (PDA), which can transmit the report when the smart terminal is connected to the internet. For example, the smart terminal can include an electronic device having a memory, a microprocessor for executing, operating, and controlling a program.

Upon running the application or being connected to the web site to report a traffic violation, the user may be prompted to input traffic violation information at step S140, as shown in FIG. 1. The traffic violation information is the information which describes the traffic violation in detail, such as when the traffic violation occurred, where the traffic violation occurred, who drove the vehicle, or the like.

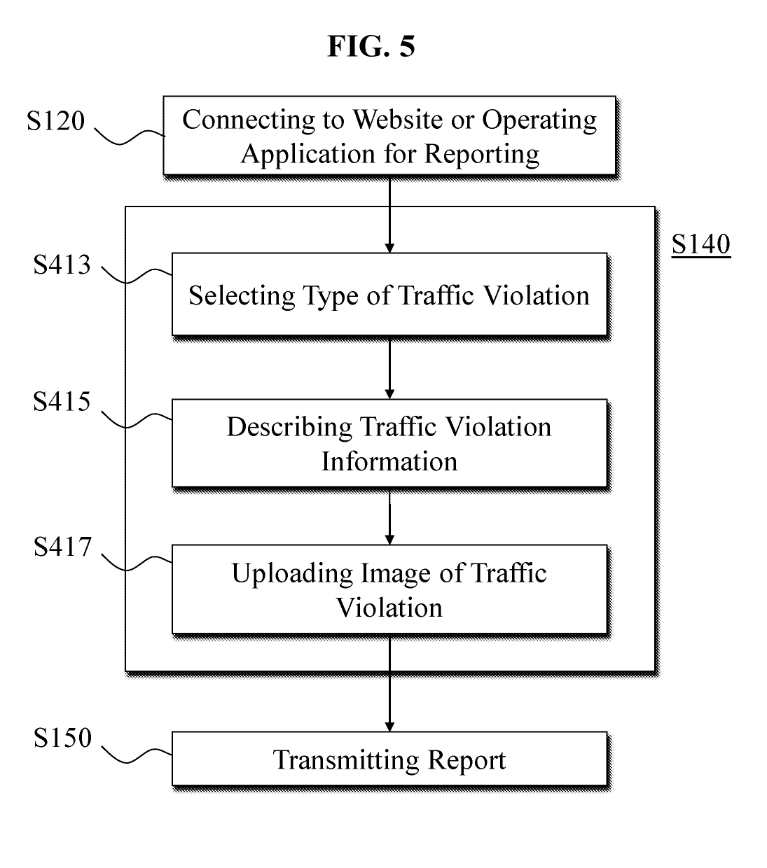

FIG. 5 is a flow chart illustrating the step of inputting the traffic violation information. The step of inputting the traffic violation information further includes a step of selecting a type of the traffic violation (step S413). The type of traffic violation may be pre-stored in the website or in the application, and the user may be able to choose at least one of the types provided therein, thereby expediting the reporting process while allowing the entire process easier and convenient. Exemplary types of the traffic violation are described above. The types of the traffic violations are not limited to those listed.

When the user chooses the type of traffic violation at step S413, the user will be given a chance to describe traffic violation information (step S415). The traffic violation information may include a plate number, the number of passengers, a date when the traffic violation occurred, a time when the traffic violation occurred, a place where the traffic violation occurred, a person who drove the vehicle, damages occurred due to the traffic violation, or the like. The traffic violation information described in this step may be used to determine the traffic violation more accurately.

Thereafter, the user may be prompted to upload the image of the traffic violation as an evidence of the traffic violation (step S417). In order to upload the image of traffic violation, the user may be necessary to retrieve the image which was previously stored in a separate storage medium or a network storage. Otherwise, when the image is stored in the device that the user is using to report the traffic violation, it may be unnecessary to retrieve the image of the traffic violation.

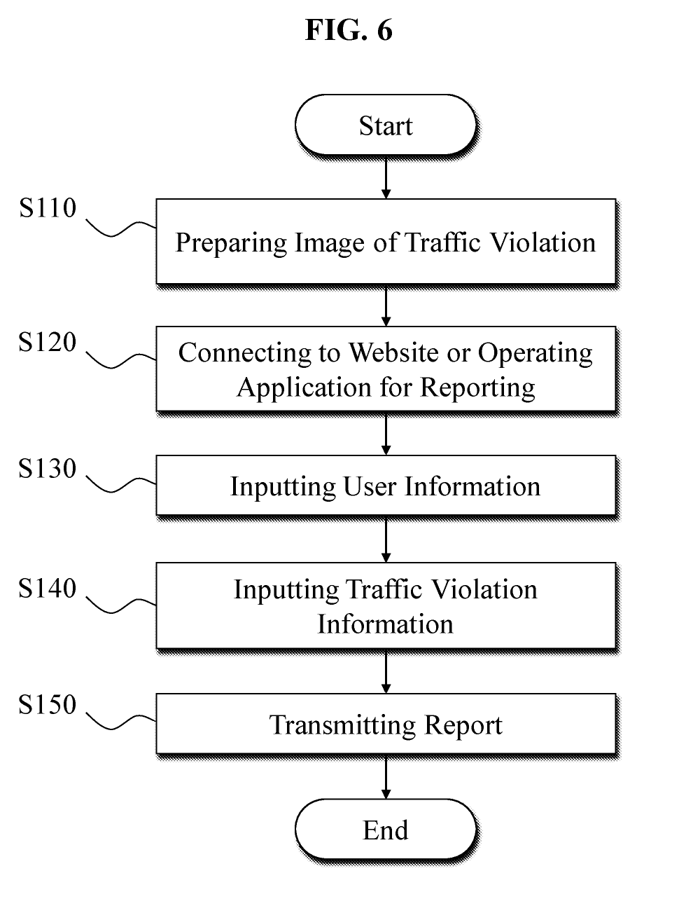

Here, the method of reporting traffic violations according to an embodiment of the present invention may further include a step of inputting user information, e.g., at step S130 as shown in FIG. 6. The user information includes a name, an address, and contact information. In order to input user information at this step, the user may choose to login in to the application or the web site if the user has an account therein. Otherwise, the user may register and create an account to log in to the application or the website. When the user has an account therein, the user may store, in advance, the user information which is associated with the account. Thus, the user may avoid the inputting of the user information.

Next, the user may be able to review the traffic violation information including the uploaded image prior to transmitting the report. The user may be provided a confirmation page or a confirmation message in which the status of the report is displayed after the user transmits the report of the traffic violation.

Therefore, according to the method of reporting traffic violations using a vehicle black box image, the driver can easily report the traffic violation which occurred in violation of the safe driving regulations. Furthermore, since the image captured by the vehicle black box is uploaded as an evidence, the driver can provide accurate traffic violation information in an easy and convenient manner.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of reporting a traffic violation, the method comprising:
preparing an image of the traffic violation;
connecting to a website where a user reports the traffic violation; and
inputting traffic violation information,
wherein the inputting of the traffic violation information comprises:
selecting a type of the traffic violation; and
uploading the image of the traffic violation as an evidence of the traffic violation.

2. The method of claim 1, wherein the inputting of the traffic violation information further comprises describing the traffic violation information, wherein the traffic violation information includes at least one of a plate number, a date and time when the traffic violation occurred, a place where the traffic violation occurred, or the number of passengers.

3. The method of claim 2, wherein the preparing of the image includes:
capturing the image of the traffic violation by an electronic recording device; and
storing the image of the traffic violation in the electronic recording device or in a separate storage medium other than the electronic recording device.

4. The method of claim 3, wherein the preparing of the image further includes retrieving the image of the traffic violation from the electronic recording device or the separate storage medium other than the electronic recording device.

5. The method of claim 2, wherein the type of the traffic violation includes at least one of a speed violation, a signal violation, a lane violation, reckless driving, sudden stopping, driving in a “no-passing” zone, a rotation violation, driving in a bus-only lane, intersection blocking, a parking violation, unlawful road occupation, a usage of a cellular phone while driving, or illegal littering.

6. The method of claim 3, wherein the separate storage medium includes at least one of a smart phone storage, a cellular phone storage, a laptop storage, a personal computer storage, or a cloud storage

7. The method of claim 2, wherein the electronic recording device includes a vehicle black box.

8. A method of reporting a traffic violation, the method comprising:
preparing an image of the traffic violation;
operating an application through which a user reports the traffic violation; and
inputting traffic violation information,
wherein the inputting of the traffic violation information comprises:
selecting a type of the traffic violation; and
uploading the image of the traffic violation as an evidence of the traffic violation.

9. The method of claim 8, wherein the inputting of the traffic violation information further comprises describing the traffic violation information, wherein the traffic violation information includes at least one of a plate number, a date and time when the traffic violation occurred, a place where the traffic violation occurred, or the number of passengers.

10. The method of claim 9, wherein the preparing of the image includes:
capturing the image of the traffic violation by an electronic recording device; and
storing the image of the traffic violation in the electronic recording device or in a separate storage medium other than the electronic recording device.

11. The method of claim 10, wherein the preparing of the image further includes retrieving the image of the traffic violation from the electronic recording device or the separate storage medium other than the electronic recording device.

12. The method of claim 9, wherein the type of the traffic violation includes at least one of a speed violation, a signal violation, a lane violation, reckless driving, sudden stopping, driving in a “no-passing” zone, a rotation violation, driving in a bus-only lane, intersection blocking, a parking violation, unlawful road occupation, a usage of a cellular phone while driving, or illegal littering.

13. The method of claim 10, wherein the separate storage medium includes at least one of a smart phone storage, a cellular phone storage, a laptop storage, a personal computer storage, or a cloud storage

14. The method of claim 9, wherein the electronic recording device includes a vehicle black box.
